(19) United States
(12) Patent Application Publication
(10) Pub. No.: US 2016/0027104 A1
(43) Pub. Date: Jan. 28, 2016

(54) SMART FORM

(71) Applicant: BANK OF AMERICA CORPORATION, CHARLOTTE, NC (US)

(72) Inventors: Rahul Mahajan, Gurgaon (IN); Raghavendran Narasimhan, Hyderabad (IN); Venkatesh Naidu, Hyderabad (IN); Navjit Moran, Delhi (IN)

(21) Appl. No.: 14/339,199

(22) Filed: Jul. 23, 2014

(51) Int. Cl. G06Q 40/02; G06F 3/0484; G06Q 10/10; G06F 17/24

(52) U.S. Cl. CPC G06Q 40/02; G06Q 10/10; G06F 17/243; G06F 3/04842

(57) ABSTRACT

Disclosed is a system for populating one or more documents. The system is typically configured to (i) initiate a presentation of a first interface to an employee, wherein the first interface comprises one or more categories associated with one or more financial institution services, (ii) receive an employee selection of the one or more categories based on at least the financial institution service provided to a customer, (iii) receive an employee selection of one or more documents associated with the one or more selected categories, wherein the one or more documents comprises one or more fields, (iv) extract one or more fields common to the one or more selected documents (v) receive customer information associated with one or more of the extracted fields and (vi) populate the one or more documents with the customer information.

### FIELD OF THE INVENTION

The present invention embraces a system for populating one or more documents. The system typically includes a processor, a memory, and a module stored in the memory. The module is typically configured to receive an employee selection of one or more documents having one or more fields; extract one or more fields common to the one or more selected documents; receive customer information associated with one or more of the extracted fields; and populate the one or more documents with the customer information.

### BACKGROUND

A well-defined document management system can directly impact the efficiency and long-term health of a financial institution. Financial institutions provide a wide range of services such as investments, loans, deposits, or the like. With the increase in the number of services provided by the financial institution, the adoption of a competent document management system has gained importance to enable financial institutions to provide efficient service to the customer.

Therefore, a need exists for an improved document management system.

### BRIEF SUMMARY

Embodiments of the present invention address the above needs and/or achieve other advantages by providing apparatuses (e.g., a system, computer program product, and/or other device) and methods for populating one or more documents.

Accordingly, in one aspect, the present invention embraces a system for populating one or more documents that includes a computer apparatus including a processor and a memory. A corresponding module is stored in the memory and is executable by the processor and configured to initiate a presentation of a first interface to an employee, wherein the first interface comprises one or more categories associated with one or more financial institution services. In response, the system may be configured to receive an employee selection of the one or more categories based on at least the financial institution service provided to a customer and one or more documents associated with the one or more categories. In one aspect, the one or more documents may include one or more fields. In response to receiving an employee selection, the system may be configured to extract one or more fields common to the one of more selected documents. Once the one or more fields are extracted, the system may be configured to receive customer information associated with one or more of the extracted fields, and then populate the one or more documents with the customer information.

In some embodiments, the module is further configured to initiate a presentation of a second interface to the customer, wherein the second interface comprises one or more of the extracted fields; receive customer input from the customer associated with the one or more extracted fields; and populate the one or more documents with the received customer input.

In some embodiments, the second interface is configured to (i) receive a global signature enabling the customer to authorize the customer input provided and (ii) populate the one or more documents with the global signature.

In some embodiments, the one or more categories and the one or more documents associated with the plurality of the financial institution services is stored in a financial institution database.

In some embodiments, the module is configured to enable the employee to retrieve on or more categories to be presented on the first interface from a financial institution database.

In some embodiments, the module is configured to determine which of the one or more fields in each of the one or more documents require customer information; determine a partial match between the one or more fields in each of the one or more documents to determine one or more common fields that require customer information; and extract the one or more fields that partially match the one or more fields in each of the one or more documents.

In some embodiments, the first interface enables the employee to generate a second interface based on at least the employee selection of one or more categories and the one or more documents associated with the one or more categories.

In some embodiments, the module is configured to enable access to the first interface, wherein enabling access further comprises receiving one or more authentication credentials associated with the employee; comparing the one or more received authentication credentials to one or more authentication credentials stored in a database to determine a match; verifying the one or more authentication credentials based on at least determining the match; and enabling the employee to access the first interface.

In some embodiments, the customer information is associated with at least one of identity data, quantitative data, descriptive data, and/or qualitative data.

In another aspect, the present invention comprises a computer program product for populating one or more documents, comprising a non-transitory computer-readable storage medium having computer-executable instructions configured to initiate a presentation of a first interface to an employee, wherein the first interface comprises one or more categories associated with one or more financial institution services; receive an employee selection of the one or more categories based on at least the financial institution service provided to a customer; receive an employee selection of one or more documents associated with the one or more selected categories, wherein the one or more documents comprises one or more fields; extract one or more fields common to the one or more selected documents; receive customer information associated with one or more of the extracted fields; and populate the one or more documents with the customer information.

In some embodiments, the non-transitory computer-readable storage medium has computer-executable instructions configured to initiate a presentation of a second interface to the customer, wherein the second interface comprises one or more of the extracted fields; receive customer input from the customer associated with one or more of the extracted fields; and populate the one or more documents with the received customer input.

In some embodiments, the non-transitory computer-readable storage medium has computer-executable instructions configured to determine which of the one or more fields in each of the one or more documents require customer information; determine a partial match between the one or more fields in each of the one or more documents to determine one or more common fields that require customer information; and extract the one or more fields that partially match the one or more fields in each of the one or more documents.

In yet another aspect, the present invention includes a method for initiating, using a computing device processor, a presentation of a first interface to an employee, wherein the first interface comprises one or more categories associated with one or more financial institution services; receiving, using a computing device process, an employee selection of the one or more categories based on at least the financial institution service provided to a customer; receiving, using a computing device processor, an employee selection of one or more documents associated with the one or more selected categories, wherein the one or more documents comprises one or more fields; extracting, using a computing device processor, one or more fields common to the one or more selected documents; receiving, using a computing device processor, customer information associated with one or more of the extracted fields; and populating, using a computing device processor, the one or more documents with the customer information.

In some embodiments, the method comprises initiating a presentation of a second interface to the customer, wherein the second interface comprises one or more of the extracted fields; receiving customer input from the customer associated with one or more of the extracted fields; and populating the one or more documents with the received customer input.

In some embodiments, the method comprises receiving customer information further comprises receiving a global signature from the customer to authorize the customer information provided, wherein the global signature is applied to the one or more documents from which the one or more fields were extracted.

In some embodiments, the method comprises enabling the employee to retrieve on or more categories to be presented on the first interface from a financial institution database.

In some embodiments, the method comprises comprising enabling the employee to generate the second interface based on at least the employee selection of one or more categories and the one or more documents associated with the one or more categories.

In some embodiments, the method comprises determining which of the one or more fields in each of the one or more documents require customer information; determining a partial match between the one or more fields in each of the one or more documents to determine one or more common fields that require customer information; and extracting the one or more fields that partially match the one or more fields in each of the one or more documents.

In some embodiments, the method comprises receiving, using a computing device processor, one or more authentication credentials associated with the employee; comparing, using a computing device processor, the one or more received authentication credentials to one or more authentication credentials stored in a database to determine a match; verifying, using a computing device processor, the one or more authentication credentials based on at least determining the match; and enabling, using a computing device processor, the employee to access the first interface.

In some embodiments, the customer information is associated with at least one of identity data, quantitative data, descriptive data, and/or qualitative data.

### BRIEF DESCRIPTION OF THE DRAWINGS

Having thus described embodiments of the invention in general terms, reference will now be made to the accompanying drawings, where:

FIG. 1 illustrates a process flow for populating one or more documents in accordance with an embodiment of the invention.

FIG. 2 presents a process flow for generating a second interface to receive information from the customer in accordance with an embodiment of the invention.

FIGS. 3A and 3B provide an exemplary embodiment of the first interface presented to an employee in accordance with an embodiment of the invention.

FIG. 4 illustrates an exemplary second interface presented to a customer in accordance with an embodiment of the invention.

FIG. 5 presents an exemplary block diagram of the system environment for implementing the process flows described herein in accordance with embodiments of the present invention

### DETAILED DESCRIPTION

Embodiments of the present invention now may be described more fully hereinafter with reference to the accompanying drawings, in which some, but not all, embodiments of the invention are shown. Indeed, the invention may be embodied in many different documents and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary customer profile that includes only personal information associated with the customer, or the like. The account is associated with and/or maintained by an entity. In other embodiments, an “entity” may not be a financial institution.

In some embodiments, a “customer” may be a financial institution customer (e.g., an account holder or a person who may have an account (e.g., banking account, credit account, or the like)). In some other embodiments, a customer may not be associated with the financial institution. In some embodiments, an “employee” may be a financial institution employee (e.g., an underwriter, a project manager, an information technology specialist, a manager, an administrator, an internal operations analyst, bank teller, or the like). In one aspect, an employee may be capable of facilitating a transaction between the entity and a customer.

Recently, document management systems have become indispensable for many organizations. The majority of the organizations need to access and consult stored customer information frequently. Thus, efficiency requirements must be considered by the document management systems in order to provide fast and accurate access to customer information. Furthermore, documents need to pass from one person to another in many of these organizations. Organizations continue to search for new methods to improve document management systems.

In this regard, a financial institution service provided to a customer may require multiple document filing requirements to be fulfilled prior to the initiation of the service. Most of these documents require substantially similar customer information. Accordingly, the present system has been developed to populate one or more documents with common fields to increase efficiency and reduce error.

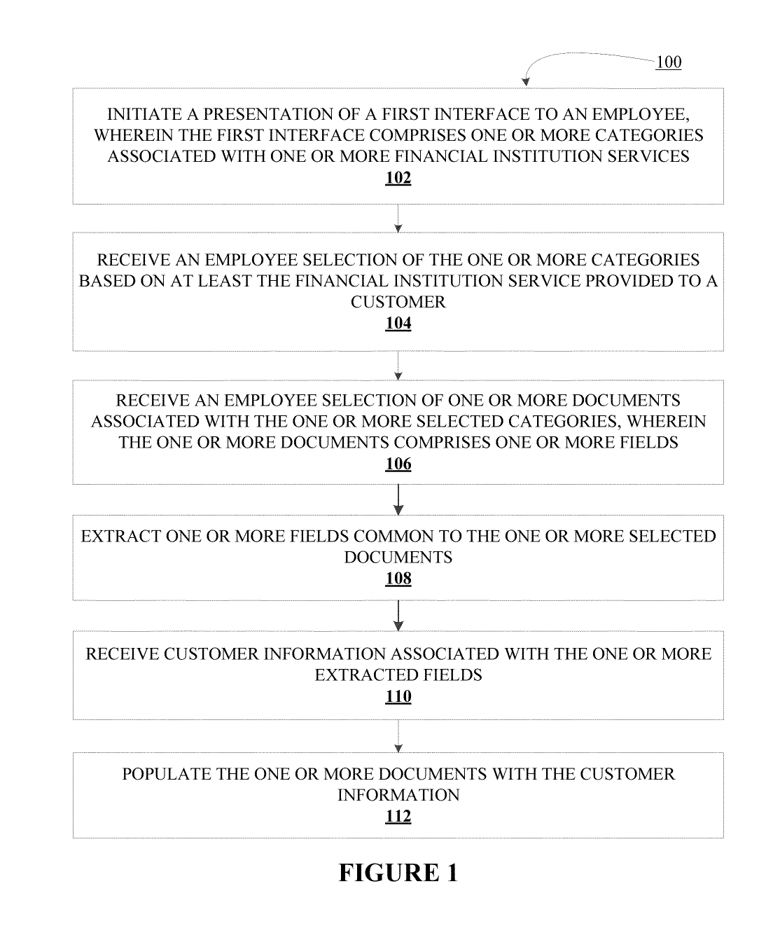

FIG. 1 illustrates a process flow 100 for populating one or more documents in accordance with an embodiment of an invention. In some embodiments, the process flow includes initiating a presentation of a first interface to an employee, wherein the first interface comprises one or more categories associated with one or more financial institution services that may be provided to a customer, as shown in block 102. In one aspect, the one or more categories may include at least one of legal documents, one or more product forms, automated overnight investment forms, general provisions and addendums, or the like.

In response to initiating the first interface, the process flow includes receiving an employee selection of one or more categories based on at least the financial institution service provided to the customer, as shown in block 104. In response to selecting the one or more categories, the process flow includes receiving an employee selection of one or more documents associated with the financial institution service provided to the customer to extract the one or more fields, as shown in block 106. In one aspect, the selected one or more documents may be required for a customer to complete to receive a financial institution service (e.g., open an account at the financial institution).

In one aspect, the one or more documents may be stored in a financial institution database. The employee may access the one or more documents in the database based on at least the financial institution service provided to the customer. Typically, financial institutions provide a wide range of comprehensive financial services including but not limited to treasury management, credit services, foreign exchange, loan/mortgage, investment banking, financial account services, or the like. In one aspect, the employee may access the first interface based on at least a verification of one or more authentication credentials. In this regard, the system may receive one or more authentication credentials from the employee, compare the received one or more authentication credentials with one or more authentication credentials stored in a financial institution database to determine a match, and based on a successful match, enable the employee access to the first interface.

Typically, the one or more documents associated with the financial institution service provided to the customer include one or more common fields. In one aspect, the one or more common fields may include identity data, quantitative data, descriptive data, and qualitative data. In some embodiments, identity data may include personal information such as name information, postal address information, career information, or the like. In some other embodiments, quantitative data may include financial information, social network activity information, or the like. In yet another embodiment, descriptive data may include family information, lifestyle details, asset information, or the like. In yet another embodiment, qualitative data may include an assessment of the customer interaction based on questionnaire type information where attitude, motivation, and opinion are provided.

In some embodiments, the process flow includes extracting one or more fields common to the one or more selected documents, as shown in block 108. In other words, it is determined which fields in the documents require the same information (e.g., name, address, and the like). In some embodiments, the one or more fields may be extracted based on at least determining a partial match between the one or more fields in each of the one or more documents (i.e., determining that at least some of the fields in the documents match).

In response to extracting the one or more fields, the process flow includes receiving customer information associated with the one or more extracted fields, as shown in block 110. The one or more extracted fields are typically common to the one or more documents associated with the financial institution service provided to the customer. In response to receiving the information, the process flow may include populating the one or more documents with the customer information, as shown in block 112. In this regard, electronic copies of the selected document may be populated with the customer information. In one embodiment, the selected documents may be combined into a single electronic document populated with the customer information. Within this document, the signature fields of each selected document may be removed and replaced with a single signature field (e.g., a single signature page after all of the documents) that applies to each pertinent selected document. This electronic document may be transmitted by the employee to the customer, or the employee may print a copy of the electronic document.

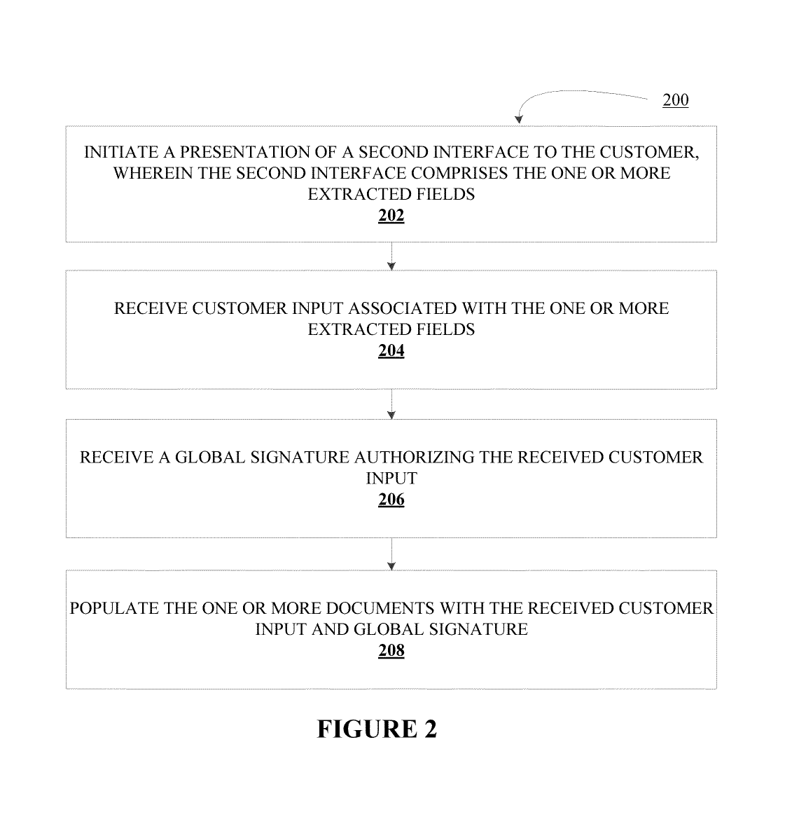

FIG. 2 presents a process flow 200 for generating a second interface to receive information from the customer. As shown in block 202, the process flow includes initiating a presentation of a second interface to the customer, wherein the second interface comprises one or more extracted fields. In response, the process flow includes receiving customer input associated with the one or more extracted fields, as shown in block 204. In response to receiving customer input, the process flow may also include receiving a global signature (e.g., an electronic signature) authorizing the received customer input, as shown in block 206. The process flow includes populating the one or more documents with the received customer input and global signature, as shown in block 208. In this regard, electronic copies of the documents may be created and populated with the received customer input. The received global signature may be used to sign each document. In this regard, the received global signature may be separately applied to each document, or the documents may be compiled into a single document having one signature page to which the received global signature may be applied. In one aspect, the customer may provide the information to the extracted one or more fields only once to complete the one or more documents, thereby reducing manual efforts and possible typographical errors. For example, the one or more fields in the information received from the customer may include financial institution checking account number, personal information, security information, or the like. In another aspect, the customer may be required to provide a signature only once, rather than spending time filling out and signing each of the one or more documents associated with the financial institution service provided to the customer. In this way, the one or more documents may be consolidated into a single document to enable and efficient document management process.

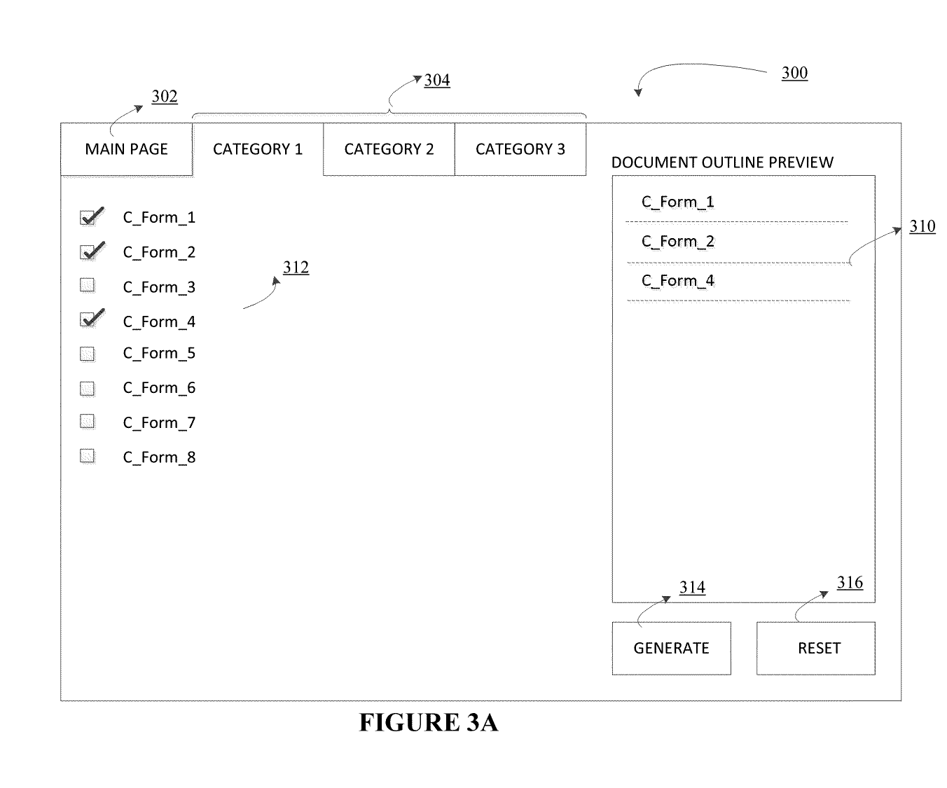

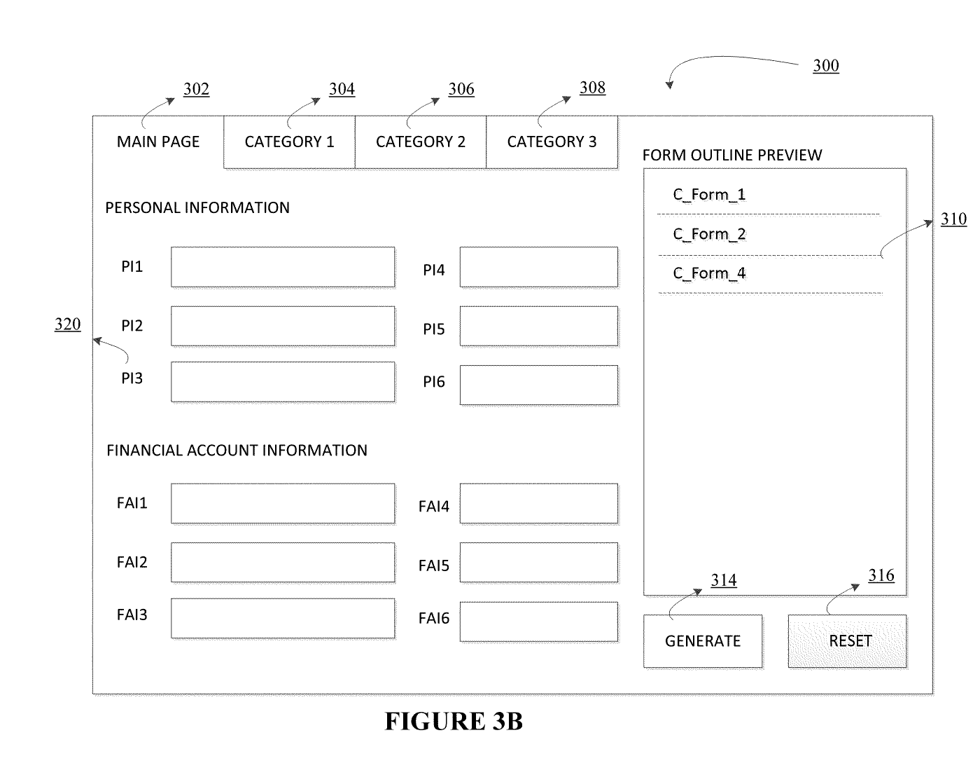

FIGS. 3A and 3B provide an exemplary embodiment of the first interface 300 in accordance with an embodiment of the invention. As shown in FIG. 3A, the first interface includes a main page 302, one or more categories 304, a document outline preview 310, a generate option 314, and a reset option 316. In some embodiments, the one or more categories may include one or more documents 312. The system may be configured to initiate the presentation of the first interface enabling the employee to select one or more documents 312 from the one or more categories available 304. In one aspect, the one or more categories may include at least one of legal documents, one or more product forms, automated overnight investment forms, general provisions and addendums, or the like.

As shown in FIG. 3A, the one or more documents 312 may be selected by virtue of a selectable check box. Each selection may be reflected in the document outline preview 310 showing the one or more selected documents from the one or more categories available to the employee. In some embodiments, the one or more documents and the one or more categories may be customizable. In another embodiment, the one or more documents and the one or more categories may be stored in a financial institution database enabling the employee to choose the one or more documents and/or the one or more categories to be retrieved.

As shown in FIG. 3B, in response to the employee selection of the one or more documents the system may be configured to extract common information fields 320 from the one or more documents and populate the main page 302 with the one or more extracted fields and one or more text boxes for customer input. In one aspect, the one or more extracted fields may be associated with at least one of identity data, quantitative data, descriptive data, and/or qualitative data. In response to selecting the one or more forms, the employee may use the generate option 314 to populate the one or more documents with the customer information. In one aspect, the employee may use the reset option 316 to deselect the one or more forms and restart the process. In some embodiments, the employee may use the generate option 314 to generate a second interface to be presented to the customer.

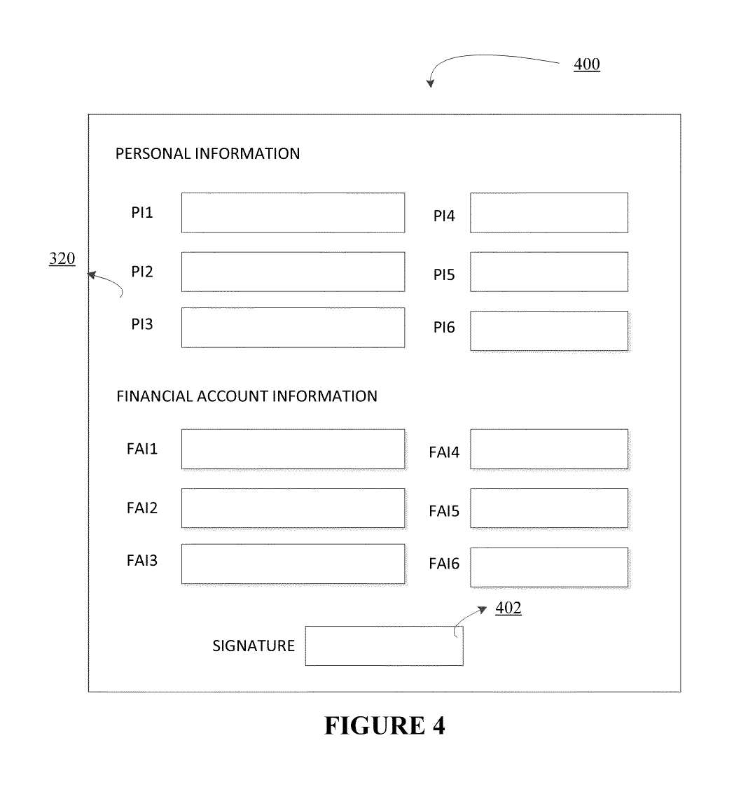

FIG. 4 illustrates an exemplary second interface 400 in accordance with an embodiment of the invention. In some embodiments, the second interface includes the one or more extracted fields 320 and a signature field 402. In one aspect, the system may be configured to initiate the presentation of the second interface based on at least the financial institution service provided to the customer. In response, the system may receive one or more customer inputs associated with the one or more extracted fields and a corresponding global signature from the customer. The system may then automatically populate the one or more selected documents 312 with the received customer input and apply the global signature to the one or more selected documents. In this way, the customer may provide the necessary information by completing the requisite documents in a more efficient manner.

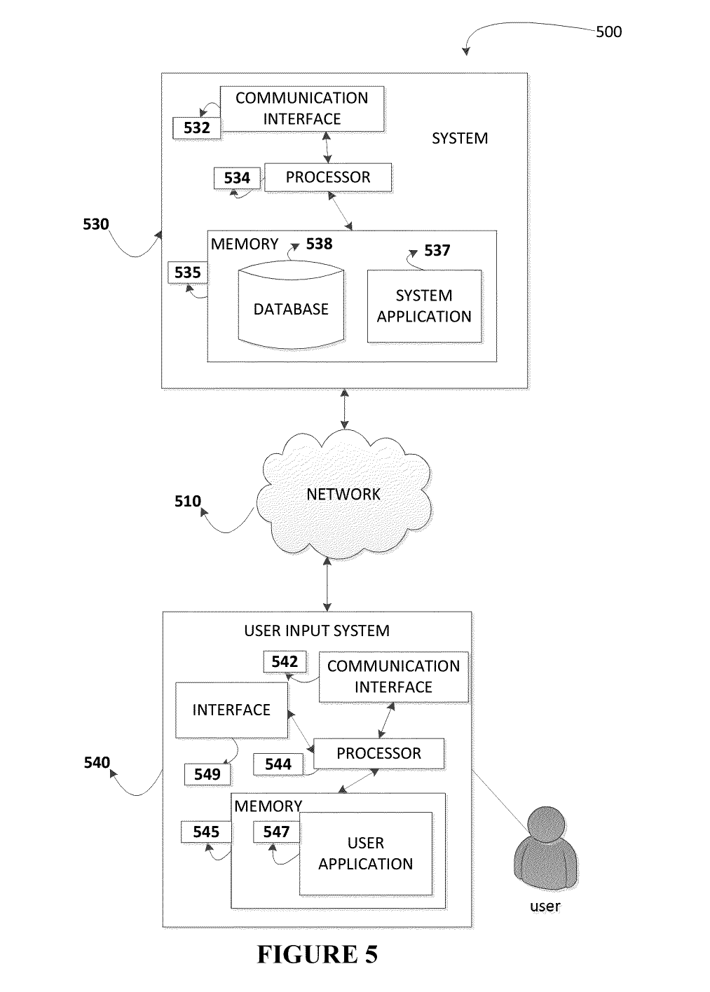

FIG. 5 presents an exemplary block diagram of the system environment 500 for implementing the process flows described herein in accordance with embodiments of the present invention. As illustrated, the system environment 500 includes a network 510, a system 530, and a user input system 540. Also shown in FIG. 5, is a user, who may be an employee or a customer. The user input system 540 may be a mobile device or other non-mobile computing device. The user application 547 may be an application to communicate with the system 530, perform a transaction, input information onto an interface presented on the user input system 540, or the like. The user application 547 and/or the system application 537 may incorporate one or more parts of any process flow described herein.

As shown in FIG. 5, the system 530, and the user input system 540 are each operatively and selectively connected to the network 510, which may include one or more separate networks. In addition, the network 510 may include a telecommunication network, local area network (LAN), a wide area network (WAN), and/or a global area network (GAN), such as the Internet. It will also be understood that the network 510 may be secure and/or unsecure and may also include wireless and/or wired and/or optical interconnection technology.

The user input system 540 may include any computerized apparatus that can be configured to perform any one or more of the functions of the user input system 540 described and/or contemplated herein. For example, the user may use the user input system 540 to transmit and/or receive information or commands to and from the system 530. In some embodiments, for example, the user input system 540 may include a personal computer system (e.g. a non-mobile or non-portable computing system, or the like), a mobile computing device, a personal digital assistant, a mobile phone, a tablet computing device, a network device, and/or the like. As illustrated in FIG. 5, in accordance with some embodiments of the present invention, the user input system 540 includes a communication interface 542, a processor 544, a memory 546 having a user application 547 stored therein, and an interface 549. In such embodiments, the communication interface 542 is operatively and selectively connected to the processor 544, which is operatively and selectively connected to the interface 549 and the memory 546. In some embodiments, the user may use the user application 547 to execute processes described with respect to the process flows described herein. Specifically, the user application 547 executes the process flows described herein.

Each communication interface described herein, including the communication interface 542, generally includes hardware, and, in some instances, software, that enables the user input system 540, to transport, send, receive, and/or otherwise communicate information to and/or from the communication interface of one or more other systems on the network 510. For example, the communication interface 542 of the user input system 540 may include a wireless transceiver, modem, server, electrical connection, and/or other electronic device that operatively connects the user input system 540 to another system such as the system 530. The wireless transceiver may include a radio circuit to enable wireless transmission and reception of information. Additionally, the user input system 540 may include a positioning system. The positioning system (e.g. a global positioning system (GPS), a network address (IP address) positioning system, a positioning system based on the nearest cell tower location, or the like) may enable at least the user input system 540 or an external server or computing device in communication with the user input system 540 to determine the location (e.g. location coordinates) of the user input system 540.

Each processor described herein, including the processor 544, generally includes circuitry for implementing the audio, visual, and/or logic functions of the user input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 547 of the memory 546 of the user input system 540.

Each memory device described herein, including the memory 546 for storing the user application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the user application 547. In some embodiments, the user application 547 includes an interface for communicating with, navigating, controlling, configuring, and/or using the user input system 540. In some embodiments, the user application 547 includes computer-executable program code portions for instructing the processor 544 to perform one or more of the functions of the user application 547 described and/or contemplated herein. In some embodiments, the user application 547 may include and/or use one or more network and/or system communication protocols.

Also shown in FIG. 5 is the interface 549. In some embodiments, the interface 549 includes one or more output devices, such as a display and/or speaker, for presenting information to the user. In some embodiments, the interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the interface 549 includes the input and display devices of a mobile device, which are operable to receive and display information.

FIG. 5 also illustrates a system 530, in accordance with an embodiment of the present invention. The system 530 may refer to the “apparatus” described herein. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. Therefore, the system 530 may be a server managed by the entity. The system 530 may be located at the facility associated with the entity or remotely from the facility associated with the entity. In some embodiments, such as the one illustrated in FIG. 5, the system 530 includes a communication interface 532, a processor 534, and a memory 536, which includes a system application 537 and a structured database 538 stored therein. As shown, the communication interface 532 is operatively and selectively connected to the processor 534, which is operatively and selectively connected to the memory 536.

It will be understood that the system application 537 may be configured to implement any one or more portions of the various interfaces and/or process flow described herein. The system application 537 may interact with the user application 547. It will also be understood that, in some embodiments, the memory includes other applications. It will also be understood that, in some embodiments, the system application 537 is configured to communicate with the structured database 538, the user input system 540, or the like.

It will be further understood that, in some embodiments, the system application 537 includes computer-executable program code portions for instructing the processor 534 to perform any one or more of the functions of the system application 537 described and/or contemplated herein. In some embodiments, the system application 537 may include and/or use one or more network and/or system communication protocols.

In addition to the system application 537, the memory 536 also includes the structured database 538. As used herein, the structured database 538 may be one or more distinct and/or remote databases. In some embodiments, the structured database 538 is not located within the system and is instead located remotely from the system. In some embodiments, the structured database 538 stores information or data described herein.

It will be understood that the structured database 538 may include any one or more storage devices, including, but not limited to, datastores, databases, and/or any of the other storage devices typically associated with a computer system. It will also be understood that the structured database 538 may store information in any known way, such as, for example, by using one or more computer codes and/or languages, alphanumeric character strings, data sets, figures, tables, charts, links, documents, and/or the like. Further, in some embodiments, the structured database 538 may include information associated with one or more applications, such as, for example, the system application 537. It will also be understood that, in some embodiments, the structured database 538 provides a substantially real-time representation of the information stored therein, so that, for example, when the processor 534 accesses the structured database 538, the information stored therein is current or substantially current.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. It will also be understood that the system 530 may include and/or implement any embodiment of the present invention described and/or contemplated herein. For example, in some embodiments, the system 530 is configured to implement any one or more of the embodiments of the process flows described and/or contemplated herein in connection any process flow described herein. Additionally, the system 530 or the user input system 540 is configured to initiate presentation of any of the interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for populating one or more documents, the system comprising:
a computer apparatus including a processor and a memory; and
a module stored in the memory, executable by the processor and configured to:
initiate a presentation of a first interface to an employee, wherein the first interface comprises one or more categories associated with one or more financial institution services;
receive an employee selection of the one or more categories based on at least the financial institution service provided to a customer;
receive an employee selection of one or more documents associated with the one or more selected categories, wherein the one or more documents comprises one or more fields;
extract one or more fields common to the one or more selected documents;
receive customer information associated with one or more of the extracted fields; and
populate the one or more documents with the customer information.

2. The system of claim 1, wherein the module is further configured to:
initiate a presentation of a second interface to the customer, wherein the second interface comprises one or more of the extracted fields;
receive customer input from the customer associated with one or more of the extracted fields; and
populate the one or more documents with the received customer input.

3. The system of claim 2, wherein the second interface is configured to (i) receive a global signature enabling the customer to authorize the customer input provided and (ii) populate the one or more documents with the global signature.

4. The system of claim 1, wherein the one or more categories and the one or more documents associated with the plurality of the financial institution services is stored in a financial institution database.

5. The system of claim 1, wherein the module is configured to enable the employee to retrieve on or more categories to be presented on the first interface from a financial institution database.

6. The system of claim 1, wherein the module is configured to:
determine which of the one or more fields in each of the one or more documents require customer information;
determine a partial match between the one or more fields in each of the one or more documents to determine one or more common fields that require customer information; and
extract the one or more fields that partially match the one or more fields in each of the one or more documents.

7. The system of claim 1, wherein the first interface enables the employee to generate a second interface based on at least the employee selection of one or more categories and the one or more documents associated with the one or more categories.

8. The system of claim 1, wherein the module is configured to enable access to the first interface, wherein enabling access further comprises:
receiving one or more authentication credentials associated with the employee;
comparing the one or more received authentication credentials to one or more authentication credentials stored in a database to determine a match;
verifying the one or more authentication credentials based on at least determining the match; and
enabling the employee to access the first interface.

9. The system of claim 1, wherein the customer information is associated with at least one of identity data, quantitative data, descriptive data, and/or qualitative data.

10. A computer program product for populating one or more documents, comprising a non-transitory computer-readable storage medium having computer-executable instructions configured to:
initiate a presentation of a first interface to an employee, wherein the first interface comprises one or more categories associated with one or more financial institution services;
receive an employee selection of the one or more categories based on at least the financial institution service provided to a customer;
receive an employee selection of one or more documents associated with the one or more selected categories, wherein the one or more documents comprises one or more fields;
extract one or more fields common to the one or more selected documents;
receive customer information associated with one or more of the extracted fields; and
populate the one or more documents with the customer information.

11. The computer program product according to claim 10, wherein the non-transitory computer-readable storage medium has computer-executable instructions configured to:
initiate a presentation of a second interface to the customer, wherein the second interface comprises one or more of the extracted fields;
receive customer input from the customer associated with one or more of the extracted fields; and
populate the one or more documents with the received customer input.

12. The computer program product according to claim 10, wherein the non-transitory computer-readable storage medium has computer-executable instructions configured to:
determine which of the one or more fields in each of the one or more documents require customer information;
determine a partial match between the one or more fields in each of the one or more documents to determine one or more common fields that require customer information; and
extract the one or more fields that partially match the one or more fields in each of the one or more documents.

13. A method for populating one or more documents, comprising:
initiating, using a computing device processor, a presentation of a first interface to an employee, wherein the first interface comprises one or more categories associated with one or more financial institution services;
receiving, using a computing device process, an employee selection of the one or more categories based on at least the financial institution service provided to a customer;
receiving, using a computing device processor, an employee selection of one or more documents associated with the one or more selected categories, wherein the one or more documents comprises one or more fields;
extracting, using a computing device processor, one or more fields common to the one or more selected documents;
receiving, using a computing device processor, customer information associated with one or more of the extracted fields; and
populating, using a computing device processor, the one or more documents with the customer information.

14. The method of claim 13, comprising:
initiating a presentation of a second interface to the customer, wherein the second interface comprises one or more of the extracted fields;
receiving customer input from the customer associated with one or more of the extracted fields; and
populating the one or more documents with the received customer input.

15. The method of claim 13, wherein receiving customer information further comprises receiving a global signature from the customer to authorize the customer information provided, wherein the global signature is applied to the one or more documents from which the one or more fields were extracted.

16. The method of claim 13, comprising enabling the employee to retrieve on or more categories to be presented on the first interface from a financial institution database.

17. The method of claim 13, comprising enabling the employee to generate the second interface based on at least the employee selection of one or more categories and the one or more documents associated with the one or more categories.

18. The method of claim 13, comprising:
determining which of the one or more fields in each of the one or more documents require customer information;
determining a partial match between the one or more fields in each of the one or more documents to determine one or more common fields that require customer information; and
extracting the one or more fields that partially match the one or more fields in each of the one or more documents.

19. The method of claim 13, comprising:
receiving one or more authentication credentials associated with the employee;
comparing the one or more received authentication credentials to one or more authentication credentials stored in a database to determine a match;
verifying the one or more authentication credentials based on at least determining the match; and
enabling the employee to access the first interface.

20. The method of claim 13, wherein the customer information is associated with at least one of identity data, quantitative data, descriptive data, and/or qualitative data.
